(19) United States
(12) Patent Application Publication
(10) Pub. No.: US 2024/0159001 A1
(43) Pub. Date: May 16, 2024

(54) Thermo truck with laterally disposed direct fired heating kettles and surface applicator system

(71) Applicant: Waterblasting, LLC, Stuart, FL (US)

(72) Inventor: James P. Crocker, Stuart, FL (US)

(21) Appl. No.: 18/506,058

(22) Filed: Nov. 9, 2023

Related U.S. Application Data
(60) Provisional application No. 63/382,978, filed on Nov. 9, 2022.

(51) Int. Cl. E01C 23/22; B05C 5/02; B05C 11/10; E01F 9/518

(52) U.S. Cl. CPC E01C 23/22; B05C 5/02; B05C 11/1042; E01F 9/518

(57) ABSTRACT

A surface marking truck for heating and applying thermoplastic material. The surface marking truck is comprised of laterally disposed direct fired kettles positioned within at least one firebox. The kettles are constructed and arranged to provide a platform area for placement of pallets above the kettles for storing material and refilling of each kettle. The thermoplastic material held in the kettles and totes is heated to a preferred application temperature with an application system mounted to the truck. Retro-reflective glass beads can be added to the thermoplastic during the spraying step.

### PRIORITY CLAIM

This application is related to U.S. Provisional Patent No. 63/382,978 entitled “EPOXY TRUCK WITH LATERALLY DISPOSED HEATING KETTLES AND SURFACE APPLICATOR SYSTEM” filed Nov. 9, 2022, the contents of which are incorporated herein by reference in its entirety.

### FIELD OF THE INVENTION

This invention relates generally to the field of road surface marking; and in particular, to truck mounted laterally disposed direct fired kettles and an applicator system for applying epoxy, paint, or polyurea to a road surface.

### BACKGROUND OF THE INVENTION

Road surface markings vary in form: surface level permanently affixed, surface level temporarily but not permanently affixed, higher than road surface markers, and/or mechanical devices. They are designed to inform motorists and pedestrians as to proper positioning for safe travel. Designs range from merely a daytime or nighttime visual presentation to a raised pavement marker that advises motorists by light reflection or vehicle vibration resulting from contact between the vehicles tires and the raised marker. Efforts to improve road marking systems exist in the realm of the application of such markings, adding retro-reflectivity, increasing longevity, and lowering installation cost.

More specifically, two distinctions exist for road surface markings: mechanical and non-mechanical markings. Mechanical devices may be raised or recessed into the road surface, and either reflective or non-reflective. Most mechanical road surface markings are permanent; however, some are movable. Mechanical devices include, but are not limited to Botts' dots, rumble strips, and reflective markers.

Non-mechanical markings include, but are not limited to, polyurea, epoxy, tape, and thermoplastic pavement markings. For ease of description, thermoplastic will be used throughout this specification with the knowledge that paint, polyurea and various epoxy can be substituted with minimal equipment modification. Thermoplastics conventionally consists of a resin and a catalyst. The thermoplastic may also include additives such as retro-reflective glass beads and is generally used to mark travel lanes, spaces in parking lots or special purpose spaces for disabled parking, loading zones, or time-restricted parking areas. Using thermoplastic, a road is marked by a truck commonly called a “striper.” Conventional striper trucks contain hundreds of gallons of thermoplastic material stored in vertically orientated containers mounted to the bed of the truck. The markings are controlled manually or automatically by a controller situated on the truck bed. The thermoplastic is directed through a series of hoses under pressure and applied to the roadway surface. For instance, thermoplastic applications combine a mixture of pigments, binders, and filler materials. The thermoplastic mix, usually in a brick or pellet form, is heated in the truck before being fed to the application apparatus. Temperature is the most important factor for the proper mixing, melting and bonding of thermoplastic. The thermoplastic mix is heated to a temperature between 400° F. and 440° F. and agitated, causing the thermoplastic compound to become a homogenized liquid. When applied at this temperature, the thermoplastic melts into the upper surface of the asphalt, forming a strong thermal bond.

Thermoplastic is durable for many traffic areas and can be applied through a wide range of conditions as it is admixed at point of use. The longevity of thermoplastic and its ease of application make it very cost effective for many roadway applications. A thermoplastic mixture can be highly reflective with the addition of retro-reflective glass beads.

Conventional pavement striping trucks typically include large capacity kettles that are vertically disposed. Such kettles can be quite tall and provided with various structures, such as platform steps, ladder rungs, bridges, etc., which enable operators or tenders to access and charge material into the tops of the kettles. Thermoplastic is transferred as a liquid, and conventional systems require the thermoplastic to be transferred into the vertically disposed kettles using a pump. The flow rate of the pump depends upon the viscosity of the thermoplastic; colder temperatures raise the viscosity. In operation, a striper truck may receive a volume of thermoplastic material the evening before a striping operation is to occur. In this manner, the thermoplastic materials, resin and catalyst, can be heated during off hours to the optimum temperature. At the point of application, the thermoplastic materials, resin and catalyst, are mixed. Should the thermoplastic material be exhausted, refilling of the kettle can be performed in the field by stopping the truck and refilling, or again during the off hours. Refilling of the kettle is time consuming and the transfer rate is dependent upon the viscosity of the thermoplastic materials. This is typically a slow process that increases both production time and job cost.

Another problem with known striper trucks used to apply thermoplastic is the use of high pressure pumps for the recirculation of thermoplastic material. The high pressure pumps are of a considerable expense, and the continued use of the pumps for non-spraying purposes leads to early repair and/or replacement. Still another problem with conventional striper trucks is the need for insulated delivery lines wherein the insulation can hide leaks and presents an added expense.

What is desired is an improvement to striper trucks by use of laterally disposed direct fired kettles for use in applying thermoplastic material to a road surface in a most efficient manner. The laterally disposed direct fired kettles provide room for truck mounted totes, essentially doubling the truck range and providing a real time operating system that feeds thermoplastic materials into kettles at a rate that is suitable to handle the demands of the dispensing system onto the pavement as needed on a continuous basis. Also what is needed is a circulation system that eliminates the need for insulated transfer piping.

### SUMMARY OF THE INVENTION

An improvement to surface marking devices for heating and applying thermoplastic material to roads, parking lots and the like is provided. The surface marking device is comprised of a truck incorporating laterally disposed direct fired kettles with internal heat exchangers. In a preferred embodiment, a first kettle holds yellow resin, a second kettle holds white resin, a third kettle holds a resin catalyst, and a fourth kettle holds black resin. Each kettle has an output fluidly coupled to a transfer pump.

Each kettle includes a heat exchanger for receipt of heated glycol that is circulated through a diesel burner or, in the alternative, a heat exchanger coupled to a device that produces waste heat, such as an air compressor used for applying the thermoplastic material through spray nozzles. By use of a manifold system, material transfer does not need to be insulated.

Placement of the kettles in a lateral position allows an upper side surface of the kettles to receive a platform capable of carrying thermoplastic material in the form of totes holding liquid resin and catalyst. The platform is constructed and arranged to hold four 275 gallon conventional totes positioned so as to allow gravity drainage from the totes to each respective kettle; each tote having a heating element that can be inserted into the tote for preheating of the material contents. By preheating the material within the totes, the resin and catalyst can be gravity fed, optionally by pump, from the tote to the respective kettle, allowing continuous striper operation. The kettle can be refilled as needed and, critically, refilled while the truck is moving, allowing for a continuous marking operation. Replacement of the totes may take place without causing equipment downtime.

Accordingly, it is an objective of the present invention to provide a truck for road striping that employs laterally disposed direct fired kettles for holding thermoplastic material, wherein the truck includes a platform placed above the kettles for holding multiple industrial sized pallets.

Another objective is to employ an insulated housing around the laterally disposed kettles wherein the kettles are direct fired in place of hydraulic heating.

Still another objective of the invention is to provide a truck for striping wherein thermoplastic materials can be preheated in kettles and pallets so as to eliminate down time for temperature stabilization.

Yet another objective of the invention is to provide a relatively short length truck capable of continuous roadway marking and the use of a cover to avoid contamination during liquid transferring.

Still another objective is to eliminate the need for a supply truck to accompany the main striper truck.

Yet still another objective of the invention is to increase the safety to workers by eliminating the need to work on vertically disposed kettles.

Yet still another objective of the invention is to teach the use of laterally disposed kettle for storage of glass beads wherein removal of the conventional vertical container allows for additional platform storage wherein a bead tank of glass beads can be maintained.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE FIGURES

FIG. 1 is a side view of the vehicle of the instant invention;

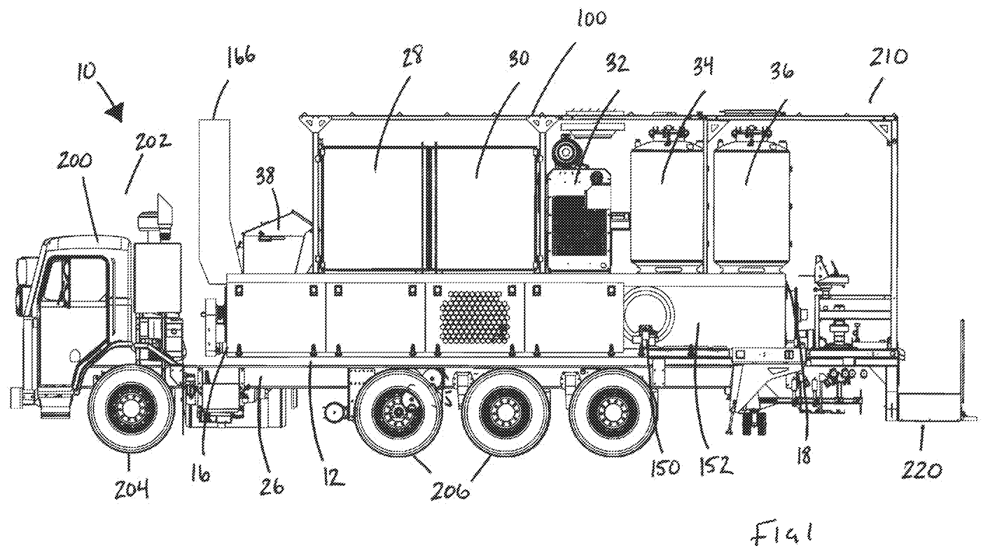

FIG. 2 is a perspective view regarding the rear section of the vehicle;

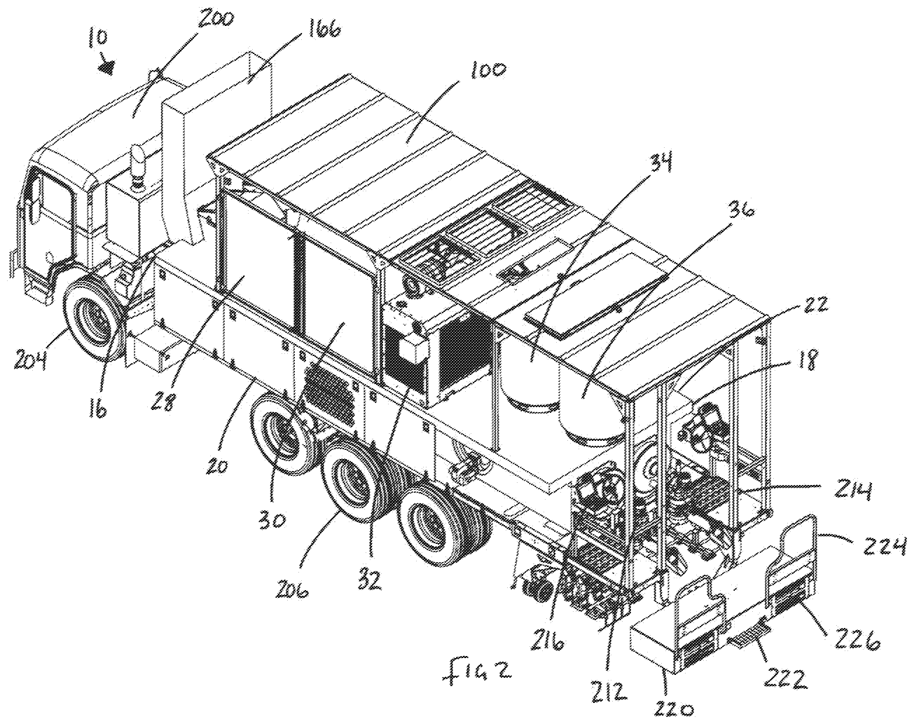

FIG. 3 is a front view regarding of the vehicle;

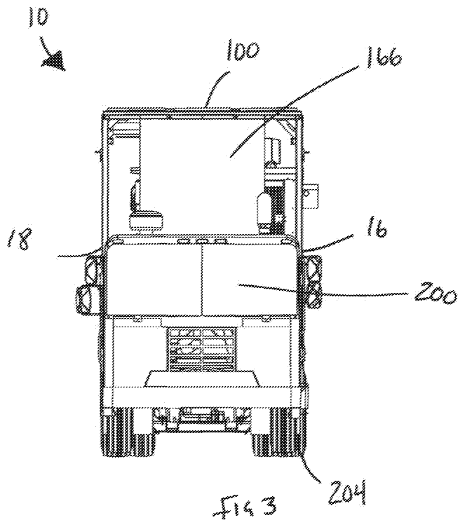

FIG. 4 is rear view thereof;

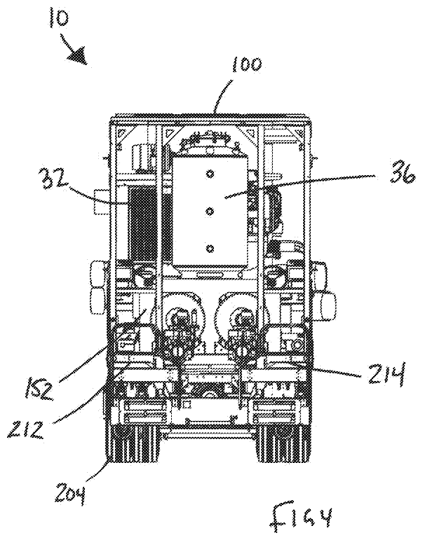

FIG. 5 is a pictorial perspective view regarding the front section of a fire box;

FIG. 6 is a front view thereof;

FIG. 7 is a pictorial perspective view regarding the rear section thereof; and

FIG. 8 is a cross-sectional side view thereof;

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

Now referring to the figures, a pavement striping truck 10 for applying thermoplastic material to a road surface is illustrated. The pavement striping truck 10 is comprised of a platform 12 having an upper surface 14 having a front edge 16, a rear edge 18, a left edge 20 and a right edge 22. Above the platform 12 and positioned on the truck chassis 26 is a fire box 152. The fire box 152 extends the length of the platform 12, from the front edge 16 to the rear edge 18. The firebox is used to melt thermoplastic material. In a preferred, either white or yellow thermoplastic material may be melted, however, the exact arrangement of colored thermoplastic material placed in the kettles of the firebox 152 is not necessary for this invention.

The thermoplastic material is held within pallets 28, 30. The pallets 28, 30 can hold different colored thermoplastic material. In this embodiment, the pallets 28, 30 may both hold yellow thermoplastic material, but can equally hold a white thermoplastic material or different colored material. For ease of understanding, pallets 28, 30 are detailed with the remaining pallets being duplicate thereto. In an alternative embodiment, the platform 12 is sized to up receive four pallets. Pallets 28, 30 can hold yellow thermoplastic material and two additional pallets (not shown in this embodiment) can hold white thermoplastic material. The pallets 28, 30 are conventional containers having forklift openings for ease of replacement. Bags of thermoplastic material taken from the pallets 28, 30 are dropped into fill chutes (x), which enter the fire box 152.

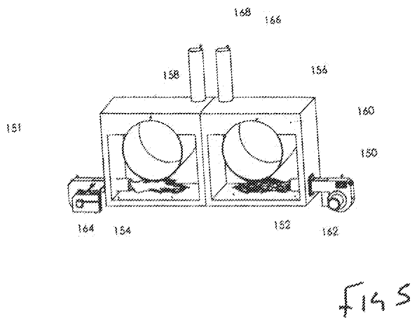

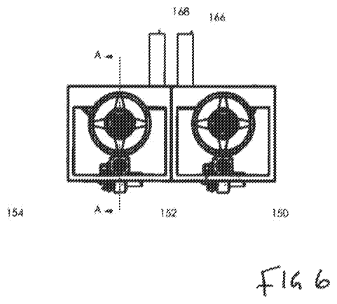

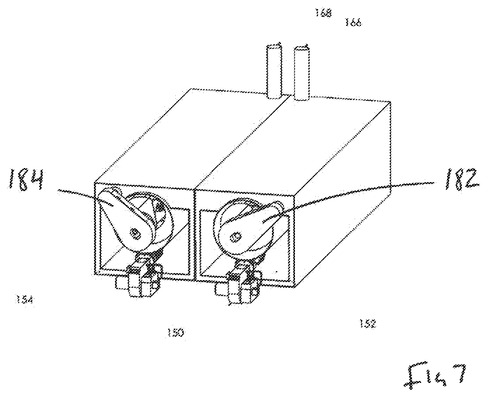

Referring now to FIGS. 5-8, set forth is an alternative embodiment wherein a burner 150 coupled directly to a firebox 152, 154 housing lateral kettles 156, 158. The fireboxes 152, 154 are insulated 160 having inlet 162, 164 and exhaust outlets 166, 168. With the direct fire embodiment, the cavity around the lateral kettle is heated by the burners 150, 151 to regulate the heat of the epoxy material carried the kettles to a preferred temperature of 425° F., typically can be controlled to a temperature up to 450° F. In this embodiment the burners are directly coupled to the firebox allowing the flow of heat through the box from the inlet to the exhaust outlet. Material movement through the kettle can be enhanced through the kettle by rotating augur 170.

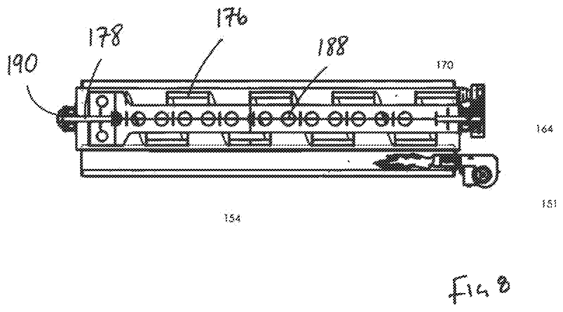

Now referring to FIG. 8, the rotating augur 170 employs wipers 176 which continuously smears molten thermoplastic material to the surface. Thermoplastic material is able to pass through the rotating augur 170 freely through openings 188, thus not creating resistance or unwanted friction which may lead to scorching of the thermoplastic material. Under high heat and stress, the rotating augur 170 has a tendency to expand and contract, which is solved by a slip shaft 178. The slip shaft 178 allows the rotating augur 170 to expand and contract without placing any pressure on the bearings and seals, such as the bearing found in a bearing housing 190. The rotating augur 170 is driven by a chain drive motor assembly 182, 184. Multiple chain drives may be employed based on the number of kettles in the system.

It is noted that FIGS. 5-8 depict only two kettles for purposes of illustration. Similar to the previous embodiments, three or four kettles can be employed with individual or community fireboxes. Additionally, more than two burners 150, 151 can be employed. The size, shape, and quantity of the burners are not limiting. In a preferred embodiment, the burners 150, 151 can be controlled individually, along with additional burners, for precision control of the heat of each kettle.

The laterally disposed kettle may also be employed for the melting of glass beads in combination with the thermoplastic material. Glass beads are stored in bead tanks 34, 36, which are pressurized up to 100 psi. The removal of the conventional vertical storage container allows for additional platform space wherein bead tanks filled with glass beads can be maintained similar to the thermoplastic material within the pallets 28, 30.

There are various devices that may be attached to the spray dispensing device to apply thermoplastic onto the pavement surface such as, but not limited to, a ribbon dispenser, spray dispensing device, screed extrusion device, or the like, not shown. The spray dispensing device results in a spray pattern that is a uniformly thick and well-defined stripe.

The pavement striping truck 10 consists of a cab 200 having a drive motor 202 mounted over a chassis 26, steering wheels 204 beneath the cab 200, and load wheels 206 beneath the chassis 26. A dual operator station 210 includes a pilot section 212 having a control panel 216 for operational display of all components. A co-pilot section 214 allows for steering of the vehicle. A carriage 220 positioned behind the operator station 210 provides a step 222 and grab rails 224 for ease of access. Bins 226 provide an area for waste collection, in particular, gun start up leaves a splatter that can be easily accessed by use of the carriage, wherein an operator can immediately address the splatter.

The term “coupled” is defined as connected, although not necessarily directly, and not necessarily mechanically. The use of the word “a” or “an” when used in conjunction with the term “comprising” in the claims and/or the specification may mean “one,” but it is also consistent with the meaning of “one or more” or “at least one.” The term “about” means, in general, the stated value plus or minus 5%. The use of the term “or” in the claims is used to mean “and/or” unless explicitly indicated to refer to alternatives only or the alternative are mutually exclusive, although the disclosure supports a definition that refers to only alternatives and “and/or.”

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements, possesses those one or more steps or elements, but is not limited to possessing only those one or more elements. Likewise, a step of a method or an element of a device that “comprises,” “has,” “includes” or “contains” one or more features, possesses those one or more features, but is not limited to possessing only those one or more features. Furthermore, a device or structure that is configured in a certain way is configured in at least that way, but may also be configured in ways that are not listed.

It is to be understood that while a certain form of the invention is illustrated, it is not to be limited to the specific form or arrangement herein described and shown. It will be apparent to those skilled in the art that various changes may be made without departing from the scope of the invention, and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention, which are obvious to those skilled in the art, are intended to be within the scope of the following claims.

What is claimed is:

1. A mobile truck apparatus for applying thermoplastic material to road surfaces, said apparatus comprising:
at least one kettle positioned laterally on a truck frame for receipt of thermoplastic material;
a firebox placed around each said kettle, said firebox having an inlet and an outlet;
a burner directly coupled to said firebox inlet, said burner directing heat to an outer surface of each said kettle for melting thermoplastic material placed within said kettle with excess heat exhausted through said firebox outlet;
a platform positioned above each said kettle, said platform available for receipt of thermoplastic material;
means for directly thermoplastic material through said kettle;
at least one container mounted to said platform for holding glass beads; and
a spraying mechanism having a spray dispensing device operatively associated with said kettle for use in mixing said thermoplastic material with glass beads for application to a road surface.
